(19) United States
(12) Patent Application Publication
(10) Pub. No.: US 2016/0061184 A1
(43) Pub. Date: Mar. 3, 2016

(54) WIND TURBINE SYSTEM

(71) Applicants: Nelson Prathish SAGAYANATHAN, CUDDALORE (IN); Subramanian RAMANATHAN, Cuddalore (IN)

(72) Inventors: Nelson Prathish SAGAYANATHAN, CUDDALORE (IN); Subramanian RAMANATHAN, Cuddalore (IN)

(21) Appl. No.: 14/474,318

(22) Filed: Sep. 2, 2014

(51) Int. Cl. F03D 3/06; F03D 3/00

(52) U.S. Cl. CPC F03D 3/067; F03D 3/002

(57) ABSTRACT

A wind turbine system (100) is provided. The system (100) may include a plurality of blades (102). Each of the blades (102) may include a first pole (104), a second pole (106), a third pole (108) and at least one flexible member (112). The first pole (104), the second pole (106) and the third pole (108) may be positioned upright. A first end (110) of each of first pole (104), the second pole (106) and the third pole (108) may be disposed at corners of a triangle (134). The flexible member (112) may be connected to at least the first pole (104) and the third pole (108) such that the second pole (106) is disposed between the first pole (104), the flexible member (112) and the third pole (108).

### BACKGROUND

1. Field

The subject matter in general relates to wind turbines.

2. Discussion of Related Art

Wind turbines harness wind's kinetic energy and convert it into electrical energy. Two of the main types of conventional wind turbines are Vertical Axis Wind Turbines (VAWT) and Horizontal Axis Wind Turbines (HAWT).

Conventionally, in VAWT, the rotor blades are positioned such that the axis of rotation of the blades is perpendicular to the direction of wind and also perpendicular to ground.

Conventionally, in HAWT, the rotor blades are positioned such that the axis of rotation is parallel to the direction of wind and also parallel to ground.

Wind turbine which may be different from conventional wind turbines may be desired.

### SUMMARY

In an embodiment a wind turbine system may be provided. The system may include a plurality of blades. Each of the blades may include a first pole, a second pole and a third pole. Each of the first pole, the second pole and the third pole may be positioned upright and a first end of each of the first pole, the second pole and the third pole may be disposed at corners of a triangle. The system may further include at least one flexible member. The flexible member may be connected to at least the first pole and the third pole such that the second pole is disposed between the first pole, the flexible member and the third pole.

### BRIEF DESCRIPTION OF DRAWINGS

Embodiments are illustrated by way of example and not limitation in the Figures of the accompanying drawings, in which like references indicate similar elements and in which:

FIG. 1A is a perspective view of an exemplary wind turbine system 100;

FIG. 1B is a perspective view of a flexible member 112 provided in blades 102 of the system 100 of FIG. 1A, wherein the flexible member 112 is in an open configuration 120;

FIG. 1C is a perspective view of the flexible member 112 provided in the blades 102 of the system 100 of FIG. 1A, wherein the flexible member 112 is in a closed configuration 118;

FIG. 1D is a side view of a pole 104, 106 or 108 which is provided in the blades 102 of the system 100;

FIG. 1E is a sectional view, about an axis A-A, of the pole 104, 106 or 108 of FIG. 1D;

FIG. 2 is a perspective view of another exemplary wind turbine system 100 in which multiple flexible members 112 are provided in each of the blades 102;

FIG. 3 is a perspective view of an exemplary alternate configuration of a blade 102 in which poles 104, 106, 108 of the blade 102 converge;

FIG. 4 is a perspective view of another exemplary alternate configuration of a blade 102 in which poles 104, 106, 108 of the blade 102 diverge.

FIG. 5A is a perspective view of another exemplary wind turbine system 500; and

FIG. 5B is another perspective view of the wind turbine system 500 of FIG. 5A.

### DETAILED DESCRIPTION

### I. OVERVIEW

### II. FIRST EXEMPLARY SYSTEM

### III. EXEMPLARY WORKING OF FIRST EXEMPLARY SYSTEM

### IV. SECOND EXEMPLARY SYSTEM

### V. CONCLUSION

### I. OVERVIEW

A wind turbine system may be provided to convert the kinetic energy of wind into electrical energy. The system may include a plurality of blades, wherein each of the blades may include a first pole, a second pole, a third pole and at least one flexible member. The first pole, the second pole and the third pole may be positioned upright. A first end of each of the first pole, the second pole and the third pole may be disposed at corners of a triangle. The flexible member may be connected to at least the first pole and the third pole such that the second pole may be disposed between the first pole, the flexible member and the third pole.

The flexible member included in the blade may be configured to transform from a closed configuration to an open configuration and vice versa. The blade may offer maximum resistance to wind when the flexible member is in the open configuration. The blade may offer minimum resistance to wind when the flexible member is in the closed configuration. The resistance offered to wind may result in rotation of the blade. The blades may rotate about an axis of rotation. The axis of rotation of the blades may be both parallel or perpendicular to ground. Further, the blades may be oriented such that the axis of rotation is perpendicular to the direction of the wind.

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description may, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### II. FIRST EXEMPLARY SYSTEM

In an embodiment, the wind turbine system 100 may be provided to convert kinetic energy from wind into electrical energy.

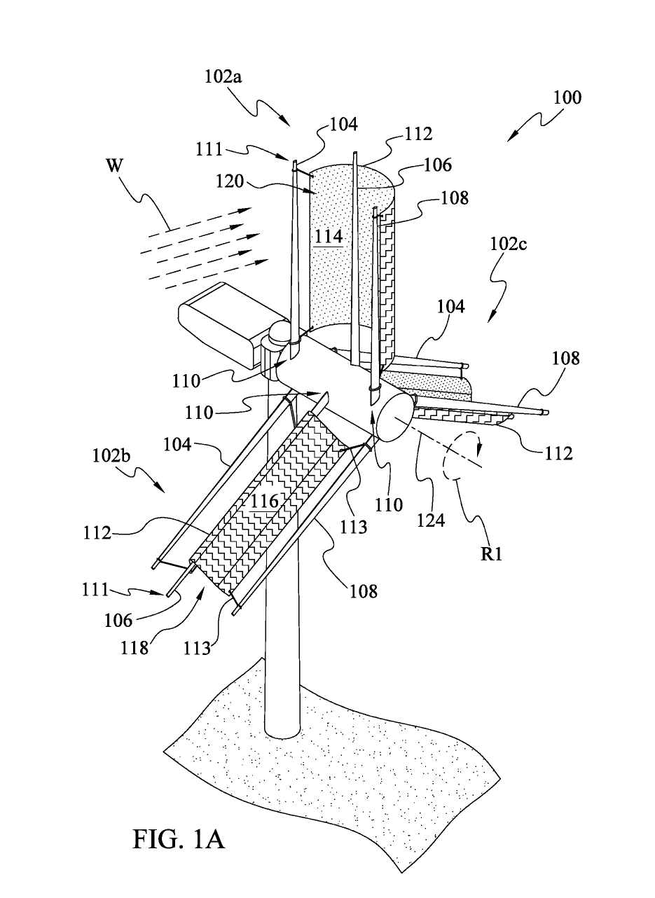

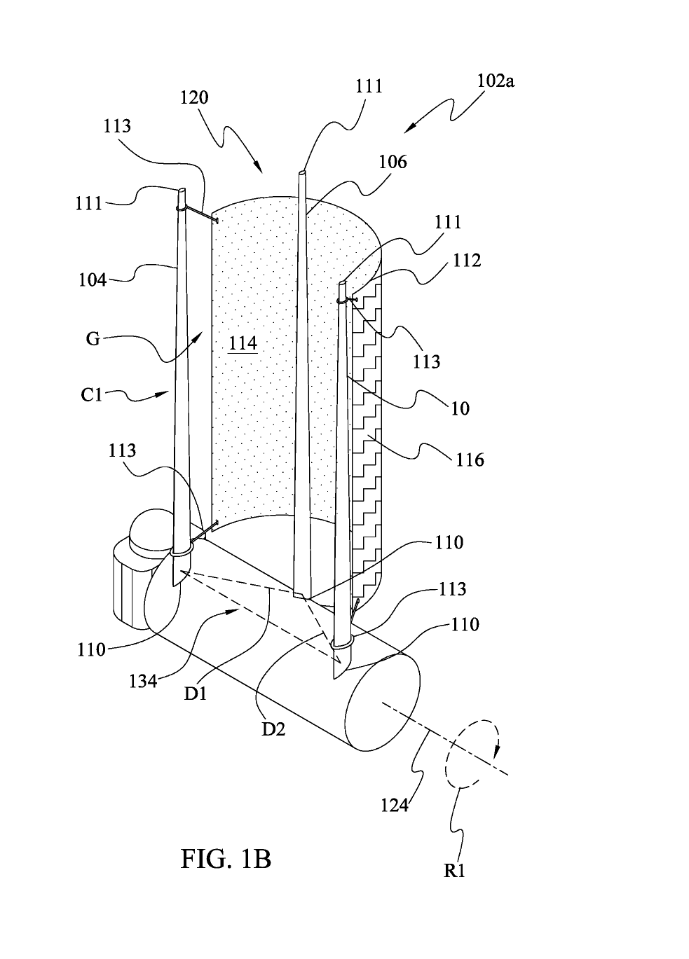

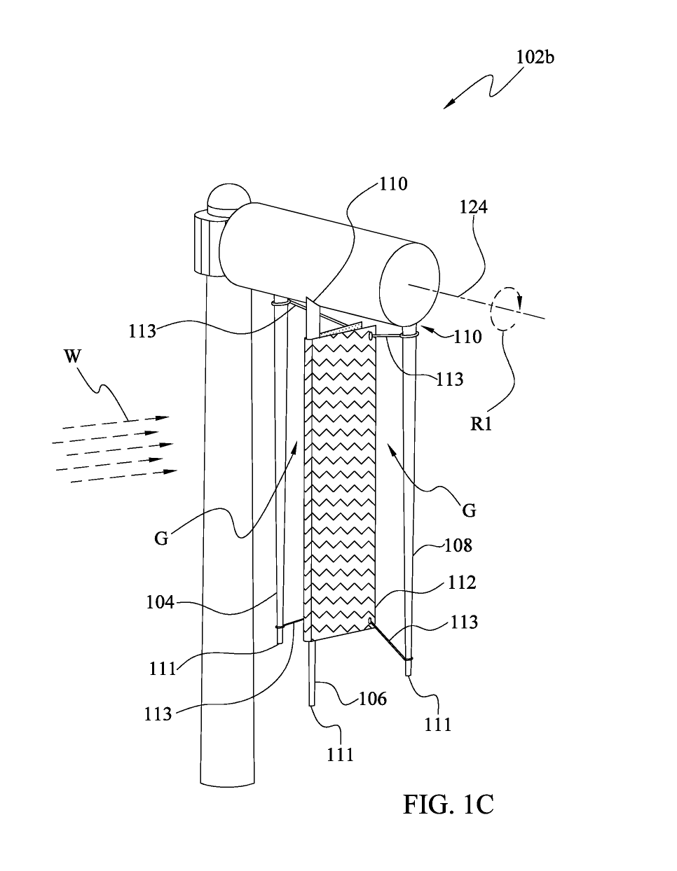

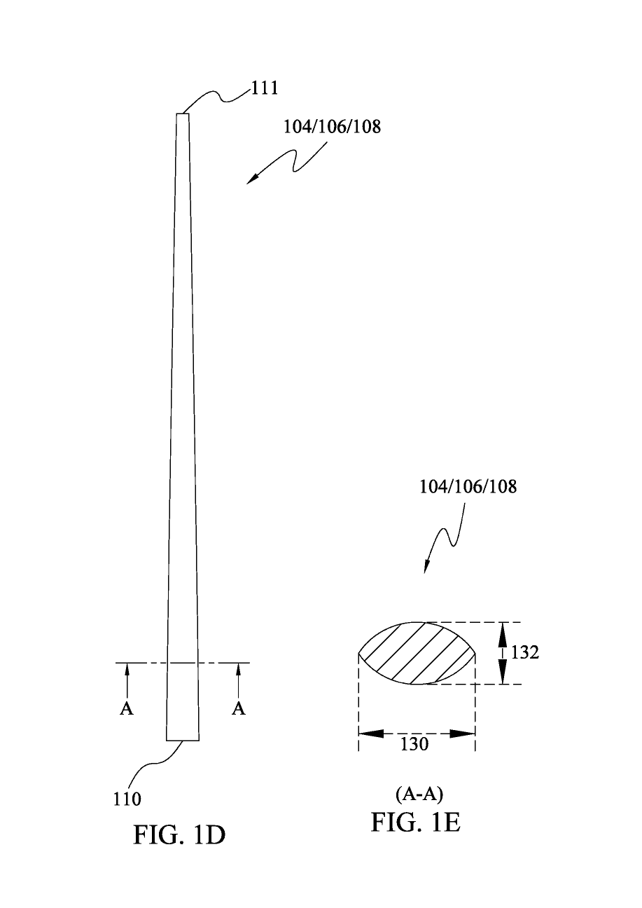

Referring to figures, and more specifically to FIG. 1A-1E, a wind turbine system 100 may include a plurality of blades 102a, 102b, 102c (the blades 102a, 102b, 102c may be collectively referred to as blades 102, or may be individually referred to as blade 102). Each of the blades 102 may include a first pole 104, a second pole 106, a third pole 108 and at least one flexible member 112.

In an embodiment, the first pole 104, the second pole 106 and the third pole 108 are positioned upright. Further, a first end 110 of each of the first pole 104, the second pole 106 and the third pole 108 are disposed at corners of a triangle 134. The flexible member 112 may be connected to at least the first pole 104 and the third pole 108. The flexible member 112 may be connected such that the second pole 106 is disposed between the first pole 104, the flexible member 112 and the third pole 108.

Referring to FIG. 1D-1E, each of the first pole 104, the second pole 106 and the third pole 108 may define an oblong cross-section having a major axis 130 and a minor axis 132. Each of the poles 104, 106 and 108 may define a cross sectional area, wherein the cross sectional area may be larger at the first end 110 compared to the cross sectional area at the end 111 opposite to the first end 110.

In an embodiment, the cross sectional area of one or more poles 104, 106 and 108 may be uniform along its length.

In an embodiment, the major axis 130 of the first pole 104 and the third pole 108 may be lengthier than the major axis 130 of the second pole 106. Further, one end of major axis 130 of each of the poles 104, 106 and 108 may be disposed along a line, while opposite ends of the major axis 130 of each of the poles 104, 106 and 108 may be disposed at corners of a triangle.

In embodiment, the cross sectional area of one or more poles 104, 106 and 108 may be decrease along one or major axis 130 and minor axis 132, as the poles 104, 106 and 108 extend from the first end 110 to the other end 111.

The blade 102 may be configured such that the distance “D1” between the first end 110 of the first pole 104 and the second pole 106 may be equal to the distance “D2” between the first end 110 of the third pole 108 and the second pole 106.

The flexible member 112 may be connected to the first pole 104 and the third pole 108 using a plurality of flexible connecting members 113. The flexible member 112 may be connected to the first pole 104 and the third pole 108 such that a gap “G” is retained between edges of the flexible member 112, and the first pole 104 and the third pole 108.

In an embodiment, the gap “G” or the length of the flexible connecting members 113 between the flexible member 112 and the first pole 104 or the second pole 106, may be half the distance between the first ends 110 of the first pole 104 and the third pole 108. The instant gap “G” may enable the flexible member 112 to completely converge about the second pole 106 in closed configuration 118, thereby offering least resistance to wind in the closed configuration 118.

The flexible member 112 may be have a rectangular (includes square) shape. In an embodiment, the corners of the flexible member 112 may be curved.

The flexible connecting members 113 may be for example a string, rope or a chain. The flexible connecting members 113 may be made for example, using alloy, polymer, fiber, natural material or synthetic material.

The flexible member 112 and the flexible connecting members 113 may be replaceable.

In an embodiment, the second pole 106 may be lengthier than the first pole 104 and the third pole 108. The lengthier configuration of the second pole 106 may enable the flexible member 112 to assume a closed configuration 118 by converging about the second pole 106, despite the fact that the flexible member 112 may drop low due to gravity and the flexible connecting members 113.

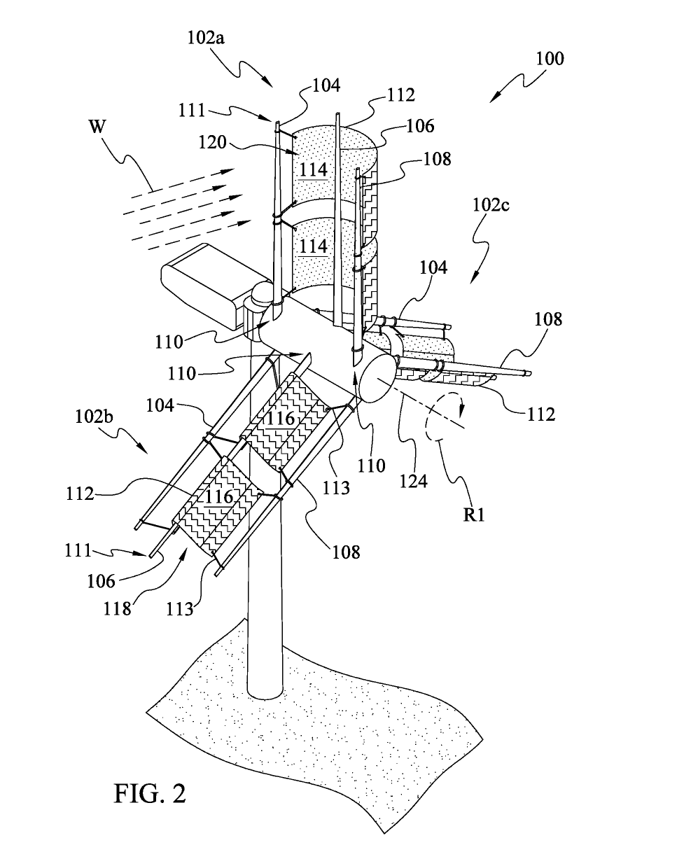

Referring to FIG. 2, in an embodiment, the blade 102 may include a plurality of flexible members 112. The plurality of flexible members 112 may be disposed along the length of the second pole 106.

In an embodiment, the flexible member 112 may include a first surface 114 and an opposing second surface 116. The flexible member 112 may be configured to transform from a closed configuration 118 (refer FIG. 1C as well) to an open configuration 120 (refer FIG. 1B as well) and vice versa upon the incidence of wind on the flexible member 112.

The first surface 114 may face substantial volume of wind in the open configuration 120, whereas the second surface 116 may face substantial volume of wind in the closed configuration 118. The first surface 114 may define a concave shape “C1” with respect to direction “W” of the wind when the flexible member 112 is in the open configuration 120. The flexible member 112 may converges towards the second pole 106 in the closed configuration 118, and the second pole 106 may prevent the flexible member 112 from assuming a single concave shape in the closed configuration 118.

The blade 102 offers maximum resistance to wind when the flexible member 112 is in the open configuration 120. The blade 102 offers minimum resistance to wind when the flexible member 112 is in the closed configuration 118.

In an embodiment, the flexible member 112 upon incidence of wind on the second surface 116, the second surface 116 may converge towards the second pole 106 such that it prevents the flexible member 112 from assuming a single concave shape in the closed configuration 118.

The blades 102 rotate about an axis of rotation 124, wherein the axis of rotation 124 may be parallel to ground.

In an embodiment, the plurality of blades 102 rotating about an axis of rotation 124 may be oriented such that the axis of rotation 124 may be perpendicular to direction “W” of wind.

In an embodiment, the plurality of blades 102 may be oriented such that the minor axis 132 of the oblong cross-section defined in each of the poles 104, 106 and 108 is perpendicular to the direction “W” of the wind, thereby defining a streamlined structure.

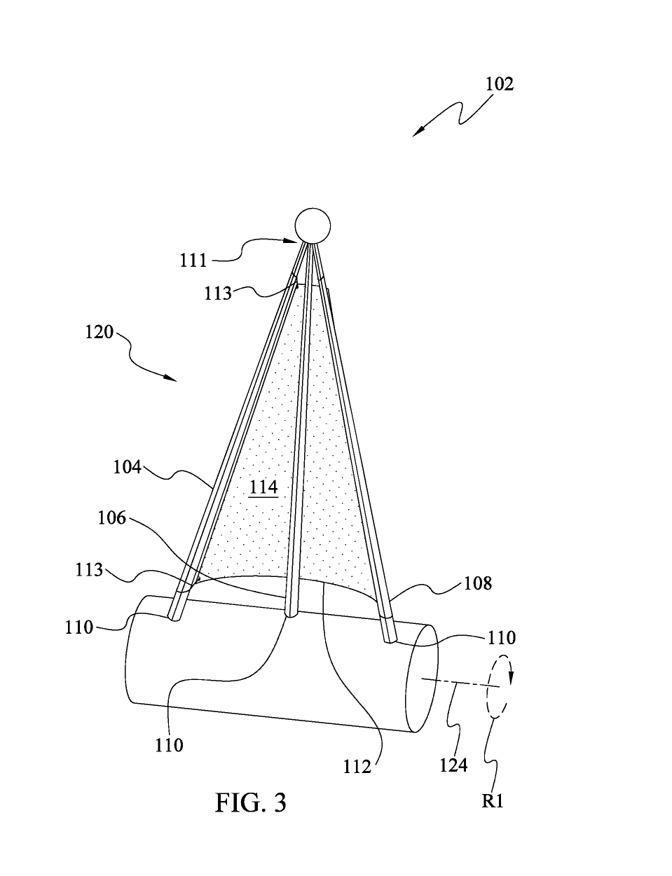

Referring to FIG. 3, in an embodiment, the first end 110 of each of the first pole 104, the second pole 106 and the third pole 108 may be disposed at corners of a triangle 134. The poles 104, 106 and 108 may superiorly extend such that they converge towards the end 111 opposite to the first end 110.

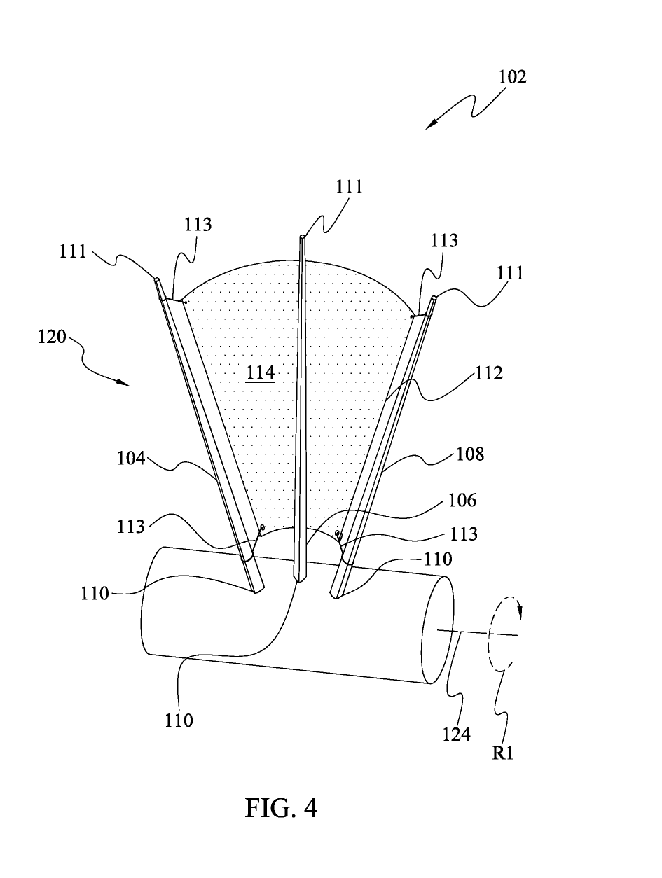

Referring to FIG. 4, in an embodiment, the first end 110 of each of the first pole 104, the second pole 106 and the third pole 108 may be disposed at corners of a triangle 134. The poles 104, 106 and 108 may superiorly extend such that they diverge towards the end 111 opposite to the first end 110.

### III. EXEMPLARY WORKING OF FIRST EXEMPLARY SYSTEM

The system 100 may include system for determining wind direction and/or wind speed and a yaw drive. The information corresponding to wind direction is used to align the nacelle over which the blades 102 may be mounted. The yaw drive may align the nacelle such that the axis of rotation 124 of the plurality of blades 102 is perpendicular to the direction “W” of the wind.

The wind force that may be pushing the blade 102a that may have assumed the open configuration 120 or may be close to assuming the open configuration 120, to rotate in the direction “R1”, may overcome the wind force that may be pushing the blade 102c that may have assumed the closed configuration 118 or may be close to assuming the closed configuration 118, to rotate the instant blade 102b in the direction opposite to “R1”, thereby enabling the blades 102 to rotate in the direction “R1”. In other words, wind force collectively acting on blades 102 to rotate the blades 102 in the direction “R1” exceeds the wind force collectively acting on blades 102 to rotate the blades 102 in the direction opposite to “R1”, thereby resulting in rotation of the blades 102 in the direction “R1”. In addition to drag force, the described configurations enable lift force to also contribute to the rotation of the blades 102.

The concept and technique of this description may be adapted to harvest tidal energy.

Although the concept and technique are illustrated using a horizontal wind turbine, the same can be adapted to a vertical wind turbine. The concept, if adapted in the vertical axis wind turbine, the axis of rotation of the blades will be perpendicular to the ground.

In an embodiment, the flexible member 112 may be connected to the second pole 106 as well.

### IV. SECOND EXEMPLARY SYSTEM

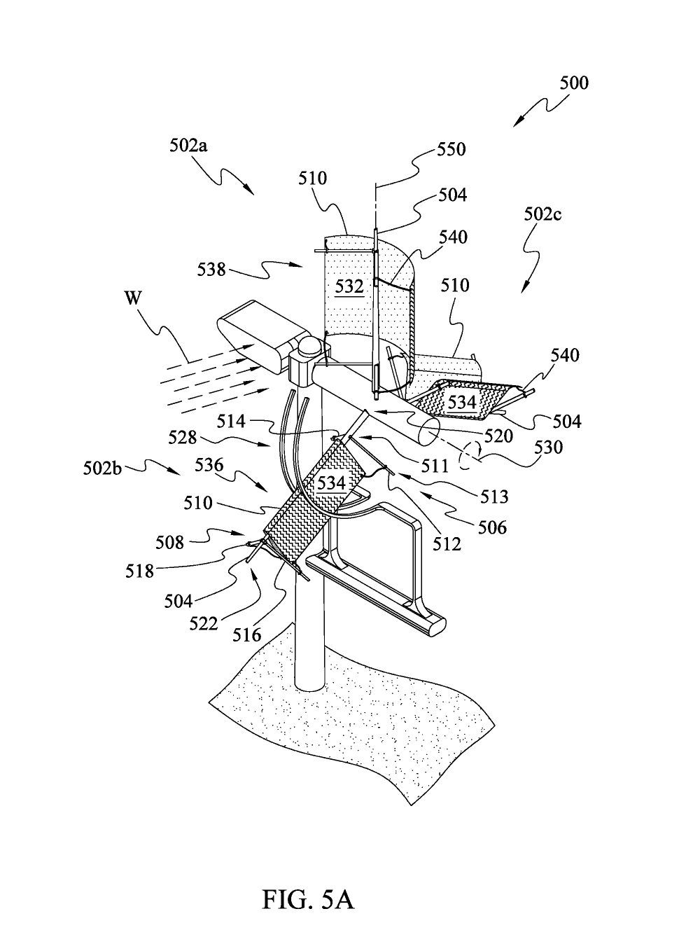

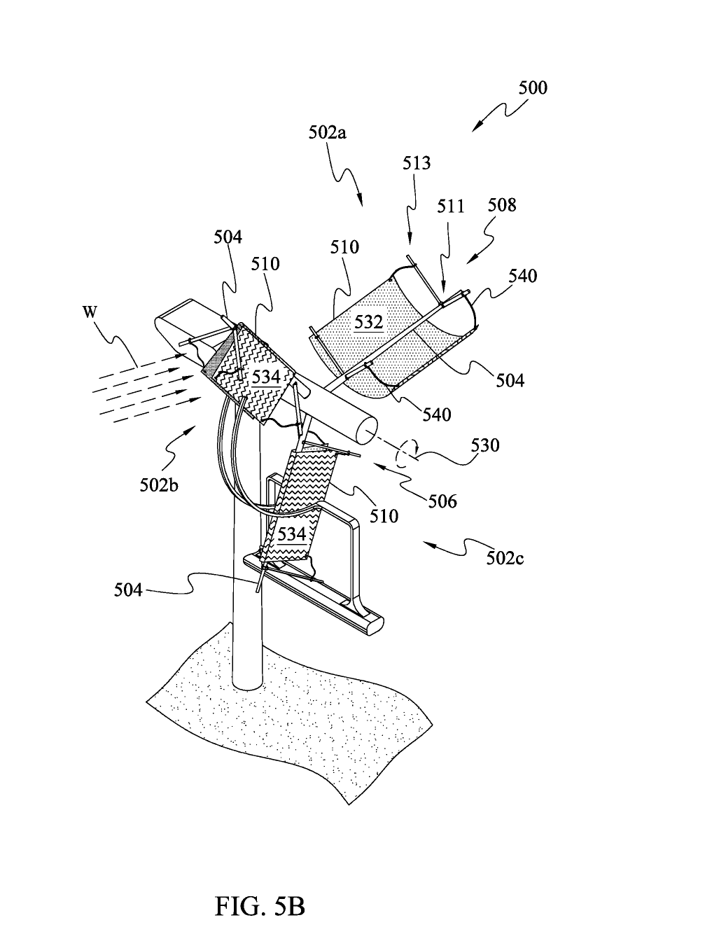

Referring to FIG. 5A-5B, a wind turbine system 500 may include a plurality of blades 502a, 502b, 502c (the blades 502a, 502b, 502c may be collectively referred to as blades 502, or may be individually referred to as blade 502) and a pair hoop structures 528. Each of the blades 502 may include a central pole 504, a first pair of arms 506, a second pair of arms 508 and a flexible member 510.

In an embodiment, the central pole 504 may be positioned upright. The first pair of arms 506 may include a first arm 512 and a second arm 514. The second pair of arms 508 may include a third arm 516 and a fourth arm 518. Each of the first arm 512, the second arm 514, third arm 516 and fourth arm 518 may include a first end 511 and a second end 513. The second end 513 may be opposite the first end 511. The first end 511 of the first arm 512 and the second arm 514 may be engaged with the central pole 504 towards the proximal end 520. The first end 511 of the first arm 512 and the second arm 514 may be engaged with the central pole 504 such that it makes an obtuse angle “θ1” with respect to each other. The first end 511 of the third arm 516 and the fourth arm 518 may be engaged with the central pole 504 towards the distal end 522. The third arm 516 and the fourth arm 518 may be engaged such that it makes an obtuse angle “θ2” with respect to each other.

Each of the first arm 512, the second arm 514, the third arm 516 and the fourth arm 518 may define edges of a triangular prism, with first arm 512 and the second arm 514 on one side of the prism, and the third arm 516 and the fourth arm 518 on the opposite side of the prism.

The central pole 504 may define an oblong cross-section having a major axis and a minor axis.

In an embodiment, the first arm 512, the second arm 514, the third arm 516 and the fourth arm 518 are engaged to the central pole 504 such that the first arm 512 and the third arm 516 lie in a plane and the second arm 514 and the fourth arm 518 lie in the opposing plane. The distance measured between each of the first end 511 of the first arm 512 and the third arm 516 along the longitudinal axis 550 of the central pole 504 may have a length “L1”. The distance between the second end 513 of the first arm 512 and the third arm 516 may have a length “L2”. Similarly, the distance between the second end 513 of the second arm 514 and the fourth arm 518 may have length “L3”.

In an embodiment, the length “L1” may greater than the length “L2”. Similarly, the length “L1” may be greater than the length “L3”.

In an embodiment, the flexible member 510 may include a first surface 532 and an opposing second surface 534. The flexible member 510 may be connected to or towards the second end 513 of each of the first arm 512, the second arm 514, the third arm 516 and fourth arm 518, such that the first surface 532 of the flexible member 510 faces the central pole 504.

In an embodiment, the flexible member 510 may be connected to or towards the second end 513 of each of the first arm 512, the second arm 514, the third arm 516 and fourth arm 518 using a plurality of connecting members 540.

The flexible member 510 may be connected to the second end 513 of each of the first arm 512, the second arm 514, the third arm 516 and fourth arm 518 such that the flexible member 510 may be disposed along the length of the central pole 504.

The flexible member 510 may be configured to transform from a closed configuration 536 to an open configuration 538 and vice versa. Upon the incidence of wind on the flexible member 510, the blade 502 may offer maximum resistance to wind in the open configuration 538 and the blades 502 may offer minimum resistance to wind in the closed configuration 536.

In an embodiment, the wind turbine system 500 may include the pair of hoop structures 528. The pair of hoop structure 528 may define a curvature. The pair of hoop structure 528 may be parallel to each other.

The hoop structure 528 may be disposed such that the central pole 504 rotating about an axis of rotation 530 passes in between the pair of hoop structure 528. Further, the first arm 512 and the second arm 514 engaged to the central pole 504 towards the proximal end 520 may reside interior to the hoop structure 530, when the central pole 504 passes through the hoop structure 528 during rotation. Whereas, the third arm 516 and the fourth arm 518 engaged to the central pole 504 towards the distal end 522 may reside exterior to the hoop structure 528 and the axis of rotation 530.

Further, the pair of hoop structure 528 may be disposed such that the central pole 504 rotating about the axis of rotation 530 and passing between the pair of hoop structure 528 forces the flexible member 510 to converge towards the central pole 504 to assume the closed configuration 536. Further, the flexible member 510 may transform from the closed configuration 536 to open configuration 538 only after the central pole 504 is incident at a preconfigured acute angle with the axis of rotation 530 of the central pole 504.

Each of the hoop structure 528 may define a cross sectional area of oblong cross-section having a major axis and a minor axis.

The first surface 532 of the flexible member 510 may face wind in the open configuration 538. The second surface 534 of the flexible member 510 may face the wind in the closed configuration 536.

In an embodiment, upon the incidence of wind on the first surface 532 the flexible member 510 transforms into the open configuration 538 to define a concave shape.

In an embodiment, the central pole 504 passing in between the pair of hoop structure 528 with the flexible member 510 is forced to converge towards the central pole 504, further the hoop structure 528 may restrict the flexible member 510 from transforming to the open configuration 538 till the central pole 504 is incident at a preconfigured acute angle with the axis of rotation 530, even when the wind may be possibly interfacing with the first surface 532 of the flexible member 510. The instant configuration may enable more efficient distribution of wind to the blades 502.

In an embodiment, the blade 102 may include a plurality of flexible members 510 and a plurality of pair of arms.

The plurality of pair of arms may be engaged to the central pole such that each of the plurality of flexible member may be connected to the second end of the said pair of arms. The plurality of flexible member 510 may be disposed along the length of the central pole 504. Further, the hoop structure 528 may be positioned such that at least one of the pluralities of flexible members 510 may pass between the pair of hoop structure 528.

In an embodiment, the hoop structures 528 may be absent.

In an embodiment, the flexible member 510 may be connected to the central pole 504 as well.

In an embodiment, instead of providing the pairs of arms as illustrated, a pair of “T” shaped members may be engaged to the central pole 504. The flexible member 510 may be connected towards the free ends of the horizontal portion of each of the “T” shaped members.

### V. CONCLUSION

Embodiments provide several advantages, and some of them are mentioned below.

Wind energy is harvested using a configuration wherein the blades are rotated about an axis that is perpendicular to the direction of the wind.

The configuration of the poles and flexible member of each of the blades ensures that the blades rotate in a single direction even though the axis of rotation is perpendicular to the direction of the wind.

It shall be noted that the processes described above is described as sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A wind turbine system comprising a plurality of blades, wherein each of the blades comprises:
a first pole, a second pole and a third pole, wherein,
each of the first pole, the second pole and the third pole are positioned upright; and
a first end of each of the first pole, the second pole and the third pole are disposed at corners of a triangle; and
at least one flexible member, wherein,
the flexible member is connected to at least the first pole and the third pole; and
the second pole is disposed between the first pole, the flexible member and the third pole.

2. The system according to claim 1, wherein the flexible member is configured to transform from a closed configuration to an open configuration and vice versa, wherein the blade offers maximum resistance to wind when the flexible member is in the open configuration, and the blade offers minimum resistance to wind when the flexible member is in the closed configuration.

3. The system according to claim 2, wherein the flexible member comprises a first surface and an opposing second surface, wherein the first surface faces the wind in the open configuration, and the second surface faces the wind in the closed configuration.

4. The system according to claim 3, wherein the first surface defines a concave shape with respect to direction of the wind when the flexible member is in the open configuration.

5. The system according to claim 4, wherein in the flexible member converges towards the second pole in the closed configuration, and the second pole prevents the flexible member from assuming a single concave shape in the closed configuration.

6. The system according to claim 1, wherein the flexible material is configured to transform from the closed configuration to the open configuration and vice versa by offering resistance to wind, wherein the resistance offered to the wind results in rotation of the blade.

7. The system according to claim 1, wherein the blades rotate about an axis of rotation, wherein the axis of rotation is parallel to ground.

8. The system according to claim 7, wherein the axis of rotation is perpendicular to direction of wind.

9. The system according to claim 1, wherein the flexible member is connected to the first pole and the third pole using a plurality of flexible connecting members.

10. The system according to claim 9, wherein a gap is retained between edges of the flexible member, and the first pole and the third pole.

11. The system according to claim 1, further comprising a plurality of flexible members, wherein the flexible members are disposed along the length of the second pole.

12. The system according to claim 1, wherein distance between the first end of the first pole and the second pole is equal to the distance between the first end of the third pole and the second pole.

13. The system according to claim 1, wherein each of the poles defines an oval cross-section having a major axis and a minor axis, wherein the minor axis is perpendicular to the direction of wind.

14. A wind turbine system comprising a plurality of blades, wherein each of the blades comprises:
a central pole, a first pair of arms, a second pair of arms and at least one flexible member, wherein,
the central pole is positioned upright;
a first end of each of the first pair of arms is engaged towards a proximal end of the central pole such that it makes an obtuse angle with respect to each other,
a first end of each of the second pair of arms is engaged towards a distal end of the central pole such that it makes an obtuse angle with respect to each other; and
the flexible member is connected to each of the first pair of arms and the second pair of arms towards an end that is opposite to the first end.

15. The system according to claim 14, further comprising a pair of hoop structures, wherein,
the central pole rotating about an axis of rotation passes in between the pair of hoop structure;
the first pair of arms resides interior to the pair of hoop structures and the axis of rotation, as the central pole rotates; and
the second pair of arms resides exterior to the pair of hoop structures, as the central pole rotates.

16. The system according to claim 14, wherein the flexible member is configured to transform from a closed configuration to an open configuration and vice versa, wherein the blade offers maximum resistance to wind when the flexible member is in the open configuration, and the blade offers minimum resistance to wind when the flexible member is in the closed configuration.

17. The system according to claim 17, wherein the flexible member comprises a first surface and an opposing second surface, wherein the first surface faces the wind in the open configuration, and the second surface faces the wind in the closed configuration.

18. The system according to claim 18, wherein the first surface defines a concave shape with respect to direction of the wind when the flexible member is in the open configuration.

19. The system according to claim 17, further comprising a pair of hoop structures, wherein the flexible member assumes the closed configuration at least when the central pole passes in between the pair of hoop structure while rotating, wherein the flexible member converges towards the central pole in the closed configuration, and the pair of hoop structure allows the flexible member to translate to assume the open configuration, only after the central pole is incident at a preconfigured acute angle with an axis of rotation of the central pole.
